(19) United States
(12) Patent Application Publication
(10) Pub. No.: US 2013/0099602 A1
(43) Pub. Date: Apr. 25, 2013

(54) LINEAR VIBRATOR

(71) Applicant: LG INNOTEK CO., LTD., Seoul (KR)

(72) Inventors: Young Il PARK, Seoul (KR); Kap Jin LEE, Seoul (KR)

(73) Assignee: LG INNOTEK CO., LTD., Seoul (KR)

(21) Appl. No.: 13/652,786

(22) Filed: Oct. 16, 2012

(30) Foreign Application Priority Data
Oct. 19, 2011 (KR) 10-2011-0106822

(51) Int. Cl. H02K 35/02

(52) U.S. Cl. 310/25

(57) ABSTRACT

A linear vibrator is disclosed, the linear vibrator including a case providing an inner space, a stator including a circuit board arranged on the case and a coil block electrically connected to the circuit board, an integral spring including a plate opposite to the circuit board and springs vibratingly fixing both distal ends of the plate to the case, a yoke arranged on the integral spring in opposition to the circuit board, and a vibrator including a weight coupled to the yoke and a magnet coupled to the weight in opposition to the coil block.

### CROSS-REFERENCE TO RELATED APPLICATION

This application claims the benefit under 35 U.S.C. §119 of Korean Patent Application No. 10-2011-0106822, filed Oct. 19, 2011, which is hereby incorporated by reference in its entirety.

### BACKGROUND

1. Field of the Disclosure

The present disclosure relates to a linear vibrator.

2. Description of Related Art

Generally, a linear vibrator is employed for generating vibration in electronic appliances, such as mobile phones, smart phones, gaming machines, portable information terminals, smart pads and game controllers, using electromagnetic force between a magnet and a coil.

A conventional linear vibrator is configured such that when a current is applied to a coil, operation of vibrator is initiated by electromagnetic force formed between the coil and the magnet to vertically vibrate the vibrator in association with elasticity of a spring relative to a stator.

However, the conventional linear vibrator has a disadvantage in that, when the vibration is generated by the vertical movement of the vibrator relative to the stator, vibration power is small and the linear vibrator comes to be voluminous. In order to solve this disadvantage, a linear vibrator has been recently developed where a vibrator is arranged on an upper surface of a stator, and the vibrator is horizontally vibrated relative to the stator to generate vibration.

The linear vibrator generating vibration with a horizontal driving is configured such that a leaf spring is coupled to a vibrator for improving the vibration power, where an area of the leaf spring is disadvantageously broken by fatigue due to repeated vibration of the vibrator.

### BRIEF SUMMARY

The present disclosure is to provide a linear vibrator configured to inhibit destruction of a leaf spring by improving vibration power during generation of vibration at the horizontal driving.

In order to achieve at least the above objects, in whole or in part, and in accordance with the purposes of the present disclosure, as embodied and broadly described, and in one general aspect of the present disclosure, there is provided a linear vibrator, the linear vibrator comprising: a case providing an inner space; a stator including a circuit board arranged on the case and a coil block electrically connected to the circuit board; an integral spring including a plate opposite to the circuit board and springs vibratingly fixing both distal ends of the plate to the case; a yoke arranged on the integral spring in opposition to the circuit board; and a vibrator including a weight coupled to the yoke and a magnet coupled to the weight in opposition to the coil block.

In another general aspect of the present disclosure, there is provided a linear vibrator, the linear vibrator comprising: a case including a bottom case and an upper case coupled to the bottom case to form an accommodation space; a stator including a circuit board arranged on the bottom case and a coil block electrically connected to the circuit board; an integral spring including a plate in opposition to the circuit board, and first and second springs each integrally formed at an edge in opposition to the plate and fixed to the case; a magnet yoke including a first yoke coupled to the first spring and a second yoke coupled to the second spring; and a vibrator including a weight coupled to the magnet yoke and a magnet coupled to the weight in opposition to the coil block.

As apparent from the foregoing, there is an advantage in the linear vibrator according to the present disclosure in that destruction of a leaf spring can be inhibited by improving vibration power during generation of vibration at the horizontal driving.

### BRIEF DESCRIPTION OF THE DRAWINGS

The accompanying drawings, which are included to provide a further understanding of the disclosure, and which are incorporated in and constitute a part of this application, illustrate embodiments of the disclosure and together with the description serve to explain the principle of the disclosure. In the drawings:

FIG. 1 is a schematic perspective view illustrating a linear vibrator according to an exemplary embodiment of the present disclosure;

FIG. 2 is a plane view illustrating a bottom case and a stator of FIG. 1;

FIG. 3 is a schematic perspective view illustrating an integral spring of FIG. 1;

FIG. 4 is a schematic perspective view illustrating a magnet yoke of FIG. 1; and

FIG. 5 is a plan view illustrating an integral spring and a magnet yoke.

### DETAILED DESCRIPTION

Hereinafter, exemplary embodiments of the present disclosure will be described in detail with reference to the accompanying drawings. In the drawings, sizes or shapes of constituent elements may be exaggerated for clarity and convenience.

In describing the present disclosure, detailed descriptions of constructions or processes known in the art may be omitted to avoid obscuring appreciation of the invention by a person of ordinary skill in the art with unnecessary detail regarding such known constructions and functions.

Accordingly, particular terms may be defined to describe the disclosure in the best mode as known by the inventors. Accordingly, the meaning of specific terms or words used in the specification and the claims should not be limited to the literal or commonly employed sense, but should be construed in accordance with the spirit and scope of the disclosure. The definitions of these terms therefore may be determined based on the contents throughout the specification.

Now, construction and operation of the linear vibrator according to the exemplary embodiments of the present disclosure will be described in detail with reference to the accompanying drawings.

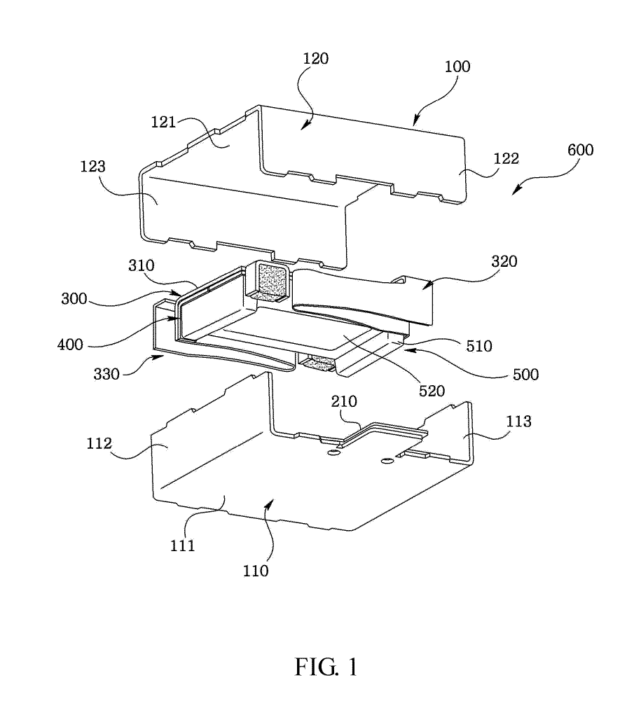

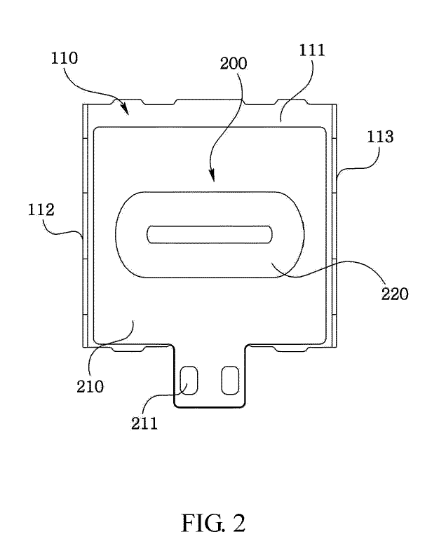

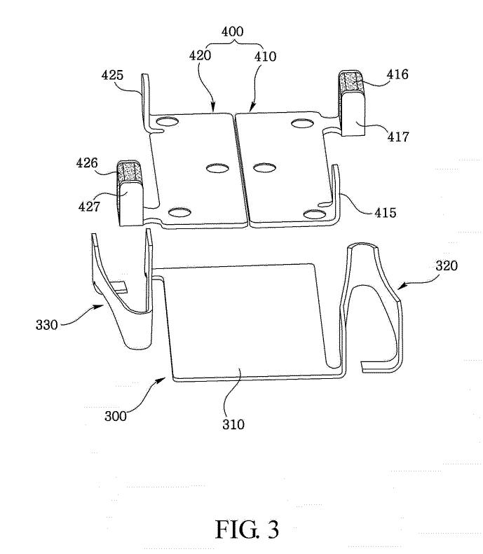

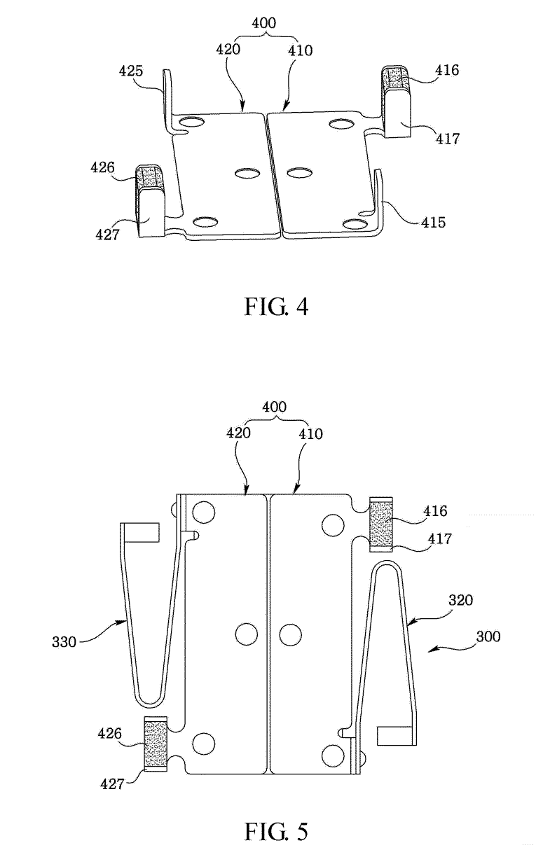

FIG. 1 is a schematic perspective view illustrating a linear vibrator according to an exemplary embodiment of the present disclosure, FIG. 2 is a plane view illustrating a bottom case and a stator of FIG. 1, FIG. 3 is a schematic perspective view illustrating an integral spring of FIG. 1, FIG. 4 is a schematic perspective view illustrating a magnet yoke of FIG. 1, and FIG. 5 is a plan view illustrating an integral spring and a magnet yoke.

Referring to FIGS. 1 to 5, a linear vibrator (500) includes a case (100), a stator (200, see FIG. 2), an integral spring (300), a yoke (400) and a vibrator (500).

The case (100) includes a bottom case (110) and an upper case (120). The bottom case (110) includes a floor plate (111) and lateral plates (112, 113) perpendicularly extended or bent relative to a floor plate (111) from both edges opposite to the floor plate (111). The upper case (120) is coupled to the bottom case (110). The upper case (120) includes a bottom case (110) and an upper case (120). The bottom case (110) includes a floor plate (121) and lateral plates (122, 123) perpendicularly extended or bent relative to a floor plate (121) from both edges opposite to the floor plate (121). The lateral plates (112, 113, 122, 123) of the bottom and upper cases (110, 120) are mutually interlinked (meshed), whereby the bottom and upper cases (110, 120) are formed therein with an inner space.

Referring to FIG. 2, the stator (200) includes a circuit board (210) and a coil block (220). The circuit board (210) is arranged on the floor plate (111) of the bottom case (110), and a part of the circuit board (210) is extended to an outside of the bottom case (1100, and the circuit board (210) extended to the outside of the bottom case (110) is formed with a connection terminal (211) applied with a driving signal.

The coil block (220) is arranged at an upper surface of the circuit board (210) and is wound in a blocky form so that an opening into which a long wire insulated by an insulation resin can be formed. Both distal ends of the wire forming the coil block (220) are electrically connected to the circuit board (210).

FIG. 3 is a schematic perspective view illustrating an integral spring extracted from FIG. 1.

Referring to FIGS. 1 and 3, the integral spring (300) serves to increase a vibration power of the linear vibrator (600) and to vibratingly fix the vibrator (500, described later) inside the case (100). The integral spring (300) includes a plate (310), a first spring (320) and a second spring (330). The plate (310) is arranged opposite the circuit board (210) arranged on the floor plate (111) of the bottom case (110). In the exemplary embodiment of the present disclosure, the plate (310) may be formed in parallel with the circuit board (210) or the floor plate (111) of the bottom case (110).

The first spring (320) is arranged to be opposite to any one of the lateral plates (122, 123) of the upper case (120). In the exemplary embodiment of the present disclosure, the first spring (320) is arranged opposite the one lateral plate (122) of the upper case (120).

The first spring (320) is formed at one edge of the plate (310) to be opposite to the lateral plate (122) of the upper case (120). In the exemplary embodiment of the present disclosure, the first spring (320) and the plate (310) are integrally formed.

The first spring (320) is formed in an adequate shape to generate elasticity by being bent at least once, and formed perpendicular to the plate (310) or in parallel with the lateral plate (122) of the upper case (120). The second spring (330) is arranged opposite to the balance of the lateral plates (122, 123) of the upper case (120). In the exemplary embodiment of the present disclosure, the second spring (330) is arranged opposite to the one lateral plate (123) of the upper case (120).

The second spring (330) is formed at an edge of the other side opposite to the one edge of the plate (310) so as to be opposite to the lateral plate (123) of the upper case (120). In the exemplary embodiment of the present disclosure, the second spring (330) and the plate (310) are integrally formed.

The second spring (330) is formed in an adequate shape to generate elasticity by being bent at least once, and formed perpendicular to the plate (310) or in parallel with the lateral plate (123) of the upper case (120).

The yoke (400) includes a first yoke (410) and a second yoke (420). The first yoke (410) is arranged on the plate (310) of the integral spring (300). The first yoke (410) is arranged on the plate (310) opposite to the circuit board (210). The first yoke (410) is formed with an area smaller than that of the plate (310), and may be formed in a rectangular shape when viewed in a top plan view. However, the first yoke (410) may be formed in other various forms than the rectangular shape.

The first yoke (410) includes a first coupling unit (415), where the first coupling unit (415) is arranged opposite to the first spring (320) integrally formed with the plate (310), and the first coupling unit (415) and the first spring (320) are mutually coupled. In the exemplary embodiment of the present disclosure, the first spring (320) and the first coupling unit (415) are mutually coupled by welding, for example.

Meanwhile, an edge of the first yoke (410) formed with the first coupling unit (415) is formed with a damping magnet unit (417) fixing a damping magnet (416). The damping magnet (416) is arranged with a magnetic fluid that cushions a shock.

The second yoke (420) is arranged on the plate (310) of the integral spring (300). The second yoke (420) is arranged on the plate (310) to be opposite to the circuit board (210). The second yoke (420) is formed with an area smaller than that of the plate (310), and may be formed in a rectangular shape when viewed in a top plan view. However, the second yoke (420) may be formed in other various forms than the rectangular shape.

In the exemplary embodiment of the present disclosure, the first yoke (410) and the second yoke (420) are symmetrically formed. The second yoke (420) includes a second coupling unit (425), where the second coupling unit (425) is arranged opposite to the second spring (330) integrally formed with the plate (310), and the second coupling unit (425) and the second spring (330) are mutually coupled. In the exemplary embodiment of the present disclosure, the second spring (330) and the second coupling unit (425) are mutually coupled by welding, for example. Meanwhile, an edge of the second yoke (420) formed with the second coupling unit (425) is formed with a damping magnet unit (427) fixing a damping magnet (426).

In a case size of the yoke (400) is smaller than a designated size when the yoke (400) is welded to the integral spring (300) while the yoke (400) is not separated, one side of the yoke (400) may be welded to the integral spring (300), but the other side of the yoke (400) may be impossible to be welded to the integral spring (300).

Meanwhile, in a case the yoke (400) is divided into the first and second yokes (410, 420) to be coupled to the integral spring (300) in the exemplary embodiment of the present disclosure, the first and second yokes (410, 420) can be welded to the integral spring (300) regardless of the size of the yoke (400), and a gap can be formed between the first and second yokes (410, 420) in a case the yoke (400) is divided into the first and second yokes (410, 420) to be coupled to the integral spring (300).

Referring to FIG. 1 again, the vibrator (500) is arranged on the yoke (400), and the vibrator (500) is arranged opposite to the coil block (220) of the stator (200). The vibrator (500) moves in the horizontal direction of the coil block (220) of the stator (200), and a vibration is generated by reciprocal movement of the vibrator (500). The vibrator (500) includes a weight (510) and a magnet (520).

The weight (510) is formed in the shape of a rectangular parallelepiped, for example, and is centrally formed with an opening having a size and a shape adequate to fix a magnet (520, described later). The weight (510) serves to enhance the vibration power by increasing a weight of the vibrator (500). The magnet (520) is arranged on a position opposite to the coil block (220) of the stator (200) and is inserted/coupled with the opening of the weight (510). The weight (510) of the vibrator (500) may be secured to the yoke (400) by way of welding or by using an adhesive.

As apparent from the foregoing, the vibrator is coupled to the yoke coupled to the integral spring, and the yoke is divided into two pieces to be coupled to the integral spring, whereby each of the divided yokes can be welded to the integral spring.

Thus, the linear vibrator based on concept according to the present disclosure has an industrial applicability in that destruction of a leaf spring can be inhibited by improving vibration power during generation of vibration at the horizontal driving.

The above-mentioned linear vibrator according to the present disclosure may, however, be embodied in many different forms and should not be construed as limited to the embodiment set forth herein. Thus, it is intended that embodiment of the present disclosure may cover the modifications and variations of this disclosure provided they come within the scope of the appended claims and their equivalents.

What is claimed is:

1. A linear vibrator, the linear vibrator comprising:
a case providing an inner space; a stator including a circuit board arranged on the case and a coil block electrically connected to the circuit board;
an integral spring including a plate opposite to the circuit board and springs vibratingly fixing both distal ends of the plate to the case;
a yoke arranged on the integral spring in opposition to the circuit board; and
a vibrator including a weight coupled to the yoke and a magnet coupled to the weight in opposition to the coil block.

2. The linear vibrator of claim 1, wherein the springs include a first spring integrally formed on one side of the plate and a second spring integrally formed on the other side opposite to the one side.

3. The linear vibrator of claim 2, wherein the first and second springs are arranged perpendicularly to the plate and bent at least one time.

4. The linear vibrator of claim 2, wherein the first and second springs are symmetrically formed relative to a center of the plate.

5. The linear vibrator of claim 2, wherein the yoke includes a first yoke arranged on the plate and a second yoke arranged near to the first yoke on the plate.

6. The linear vibrator of claim 5, wherein the first yoke includes a first coupling unit arranged in parallel with the first spring for being coupled with the first spring, and the second yoke includes a second coupling unit arranged in parallel with the second spring for being coupled with the second spring.

7. The linear vibrator of claim 6, wherein the first coupling unit and the first spring are welded, and the second coupling unit and the second spring are welded.

8. The linear vibrator of claim 5, wherein the first and second yokes are formed near to the first and second springs, each formed with a damping magnet unit, for fixing the damping magnet.

9. The linear vibrator of claim 5, wherein the first and second yokes are coupled on the plate in opposition to the circuit board.

10. The linear vibrator of claim 5, wherein a gap is formed between the first and second yokes coupled on the plate.

11. The linear vibrator of claim 5, wherein the first and second yokes are symmetrically formed relative to a center of the plate.

12. The linear vibrator of claim 1, wherein the case includes a bottom case coupled to an upper case.

13. The linear vibrator of claim 12, wherein each distal end of the springs is coupled to an inner lateral surface of the case.

14. A linear vibrator, the linear vibrator comprising:
a case including a bottom case and an upper case coupled to the bottom case to form an accommodation space;
a stator including a circuit board arranged on the bottom case and a coil block electrically connected to the circuit board;
an integral spring including a plate in opposition to the circuit board, and first and second springs each integrally formed at an edge in opposition to the plate and fixed to the case;
a magnet yoke including a first yoke coupled to the first spring and a second yoke coupled to the second spring; and a vibrator including a weight coupled to the magnet yoke and a magnet coupled to the weight in opposition to the coil block.

15. The linear vibrator of claim 14, wherein the plate is arranged in parallel with the circuit board, and first and second springs are bent at least one time and perpendicularly formed to the plate.

16. The linear vibrator of claim 14, wherein the first magnet yoke includes a first coupling unit arranged in parallel with the first spring for being coupled with the first spring, and the second yoke includes a second coupling unit arranged in parallel with the second spring for being coupled with the second spring.

17. The linear vibrator of claim 14, wherein the first and second yokes are formed adjacent to the first and second springs, and formed with damping magnet units fixing damping magnets.

18. The linear vibrator of claim 14, wherein the first and second yokes are formed on the plate in opposition to the circuit board.

19. The linear vibrator of claim 14, wherein a gap is formed between the first and second yokes coupled to the plate.
